(19) United States
(12) Patent Application Publication
(10) Pub. No.: US 2020/0189361 A1
(43) Pub. Date: Jun. 18, 2020

(54) HYBRID-POWER TRANSPORT REFRIGERATION SYSTEMS

(71) Applicant: Carrier Corporation, Palm Beach Gardens, FL (US)

(72) Inventor: Thomas D. RADCLIFF, Vernon, CT (US)

(21) Appl. No.: 16/609,353

(22) PCT Filed: May 3, 2018
(86) PCT No.: PCT/US2018/030812

§ 371 Date: Oct. 29, 2019

Related U.S. Application Data
(60) Provisional application No. 62/502,015, filed on May 5, 2017.

(51) Int. Cl. B60H 1/32; B60P 3/20

(52) U.S. Cl. CPC B60H 1/3232; B60H 1/00428; B60P 3/20

(57) ABSTRACT

Hybrid-power transport refrigeration system (200) having a fixed-speed generator (202), a refrigeration compressor (204), a power bus (208) electrically connecting the fixed-speed generator (202) to the refrigeration compressor (204), an energy storage device (220) electrically connected to the power bus (208) and arranged to receive power from the fixed-speed generator (202) in an engine-operation mode and to supply power to the refrigeration compressor (204) in a battery-operation mode, and a DC/AC variable frequency drive electrically connected between the energy storage device (220) and the refrigeration compressor (204) to convert a DC power supply from the energy storage device (220) to a variable frequency power to drive the refrigeration compressor (204) when in the battery-operation mode.

### BACKGROUND

The subject matter disclosed herein generally relates to refrigeration systems for vehicles and, more particularly, to power management of transport refrigeration systems for vehicles.

Refrigeration systems for vehicles may be configured with cooling systems, such as cooling units, that are set up for providing cooling within a cargo space. Transport refrigeration is typically based on vapor compression cooling cycles operated by a diesel engine either through a motor/generator set or directly with a belt drive. The compressor speed is determined by the generator or motor speed (e.g., belt drive). In other configurations, cooling may be provided using direct evaporation of liquid carbon dioxide or nitrogen.

### SUMMARY

According to some embodiments, hybrid-power transport refrigeration systems are provided. The hybrid-power transport refrigeration systems include a fixed-speed generator, a refrigeration compressor, a power bus electrically connecting the fixed-speed generator to the refrigeration compressor, an energy storage device electrically connected to the power bus and arranged to receive power from the fixed-speed generator in an engine-operation mode and to supply power to the refrigeration compressor in a battery-operation mode, and a DC/AC variable frequency drive electrically connected between the energy storage device and the refrigeration compressor to convert a DC power supply from the energy storage device to a variable frequency power to drive the compressor when in the battery-operation mode.

In addition to one or more of the features described above, or as an alternative, further embodiments of the hybrid-power transport refrigeration systems may include that the DC/AC variable frequency drive comprises an AC/DC converter and a storage device controller, wherein when in the engine-operation mode, the storage device controller is configured to convert power from the fixed-speed generator and store power in the energy storage device.

In addition to one or more of the features described above, or as an alternative, further embodiments of the hybrid-power transport refrigeration systems may include that the storage device controller is further configured to reverse the AC/DC converter to a DC/AC converter and supply power to the refrigeration compressor.

In addition to one or more of the features described above, or as an alternative, further embodiments of the hybrid-power transport refrigeration systems may include a system controller in communication with at least one of the fixed-speed generator and the DC/AC variable frequency drive.

In addition to one or more of the features described above, or as an alternative, further embodiments of the hybrid-power transport refrigeration systems may include a communications bus enabling communication between the system controller and the at least one of the fixed-speed generator and the DC/AC variable frequency drive.

In addition to one or more of the features described above, or as an alternative, further embodiments of the hybrid-power transport refrigeration systems may include at least one additional load electrically connected to the fixed-speed generator and arranged to be driven by power from the fixed-speed generator.

In addition to one or more of the features described above, or as an alternative, further embodiments of the hybrid-power transport refrigeration systems may include the at least one additional load is a refrigeration fan.

In addition to one or more of the features described above, or as an alternative, further embodiments of the hybrid-power transport refrigeration systems may include a position locator element arranged to detect a position of the hybrid-power transport refrigeration system, wherein the battery-operation mode is based on the detected position.

In addition to one or more of the features described above, or as an alternative, further embodiments of the hybrid-power transport refrigeration systems may include an auxiliary power system arranged to supply power to the power bus from an auxiliary power source.

In addition to one or more of the features described above, or as an alternative, further embodiments of the hybrid-power transport refrigeration systems may include the auxiliary power source is grid power.

In addition to one or more of the features described above, or as an alternative, further embodiments of the hybrid-power transport refrigeration systems may include the engine-operation mode is a mode of operation wherein the fixed-speed generator is on and operated and the battery-operation mode is employed when the fixed-speed generator is off and shut down.

In addition to one or more of the features described above, or as an alternative, further embodiments of the hybrid-power transport refrigeration systems may include the refrigeration compressor is a variable speed compressor.

According to some embodiments, methods of operating transport refrigeration systems are provided. The methods include operating a fixed-speed generator to power a refrigeration compressor through a power bus electrically connecting the fixed-speed generator to the refrigeration compressor, storing power in an energy storage device that is electrically connected to the power bus and arranged to receive power from the fixed-speed generator in an engine-operation mode and to supply power to the refrigeration compressor in a battery-operation mode, and converting a DC power stored in the energy storage device to a variable frequency AC power to drive the compressor when in a battery-operation mode using a DC/AC variable frequency drive electrically connected between the energy storage device and the refrigeration compressor, wherein the battery-operation mode is used when the fixed-speed generator is off.

In addition to one or more of the features described above, or as an alternative, further embodiments of the methods may include that the DC/AC variable frequency drive comprises an AC/DC converter and a storage device controller. The methods further including converting power from the fixed-speed generator to store power in the energy storage device when in the engine-operation mode.

In addition to one or more of the features described above, or as an alternative, further embodiments of the methods may include reversing the AC/DC converter to a DC/AC inverter and supplying power to the refrigeration compressor.

In addition to one or more of the features described above, or as an alternative, further embodiments of the methods may include supplying power to at least one additional load that is electrically connected to the fixed-speed generator and arranged to be driven by power from the fixed-speed generator.

In addition to one or more of the features described above, or as an alternative, further embodiments of the methods may include that the at least one additional load is a fan.

In addition to one or more of the features described above, or as an alternative, further embodiments of the methods may include detecting a position of the hybrid-power transport refrigeration system using a position locator element, wherein use of the battery-operation mode is based on the detected position.

In addition to one or more of the features described above, or as an alternative, further embodiments of the methods may include supplying power from an auxiliary power system source to the power bus.

In addition to one or more of the features described above, or as an alternative, further embodiments of the methods may include that the auxiliary power source is grid power.

In addition to one or more of the features described above, or as an alternative, further embodiments of the methods may include that the engine-operation mode is a mode of operation wherein the fixed-speed generator is on and operated and the battery-operation mode is employed when the fixed-speed generator is off and shut down.

In addition to one or more of the features described above, or as an alternative, further embodiments of the methods may include that the refrigeration compressor is a variable speed compressor.

The foregoing features and elements may be combined in various combinations without exclusivity, unless expressly indicated otherwise. These features and elements as well as the operation thereof will become more apparent in light of the following description and the accompanying drawings. It should be understood, however, that the following description and drawings are intended to be illustrative and explanatory in nature and non-limiting.

### BRIEF DESCRIPTION OF THE DRAWINGS

The subject matter is particularly pointed out and distinctly claimed at the conclusion of the specification. The foregoing and other features, and advantages of the present disclosure are apparent from the following detailed description taken in conjunction with the accompanying drawings in which:

FIG. 1A is a schematic view of a truck-trailer system including a box or enclosure having a cooling unit and a cargo compartment that can employ embodiments of the present disclosure;

FIG. 1B is a detailed schematic illustration of the cooling unit of FIG. 1A;

FIG. 2 is a schematic diagram of a refrigeration system in accordance with an embodiment of the present disclosure; and

FIG. 3 is a flow process for operating a transport refrigeration system in accordance with an embodiment of the present disclosure.

### DETAILED DESCRIPTION

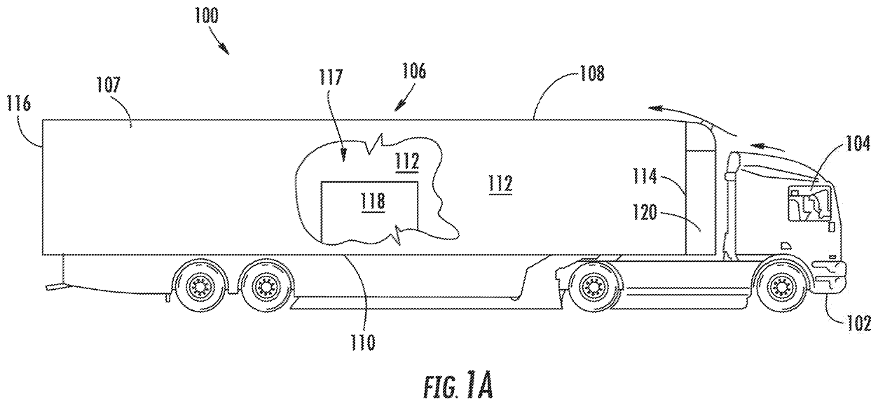

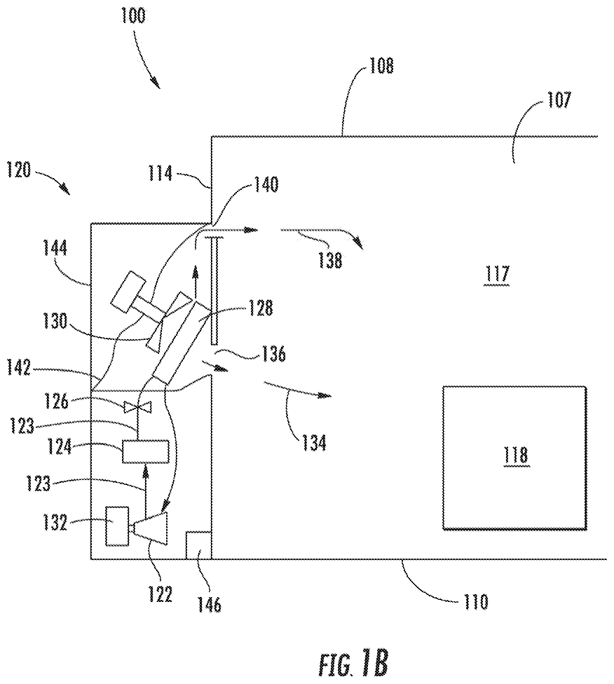

Shown in FIG. 1A is a schematic of an embodiment of an enclosure system 100 having an enclosure 106 as part of a trailer. The enclosure system 100 includes a tractor 102 including an operator's compartment or cab 104 and also including an engine, which acts as the drive system of the enclosure system 100. The enclosure 106 is coupled to the tractor 102. In the present illustration, the enclosure 106 is a refrigerated trailer and includes a top wall 108, a directly opposed bottom wall 110, opposed side walls 112, and a front wall 114, with the front wall 114 being closest to the tractor 102, the walls 108, 110, 112, 114 defining an enclosed volume 107. The enclosure 106 further includes a door or doors (not shown) at a rear wall 116, opposite the front wall 114, enabling openable access to the enclosed volume 107. The walls of the enclosed volume 107 define a cargo space 117. The enclosed volume 107 is configured to maintain a cargo 118 located inside the cargo space at a selected temperature through the use of a cooling unit 120 located on or next to the enclosed volume 107. The cooling unit 120, as shown in FIG. 1A, is located at or attached to the front wall 114.

Referring now to FIG. 1B, the cooling unit 120 is shown in more detail. The cooling unit 120 includes a compressor 122, a condenser 124 having a condenser fan, an expansion valve 126, an evaporator 128, and an evaporator fan 130. The compressor 122 is operably connected to a refrigeration engine 132 which drives the compressor 122. The refrigeration internal combustion engine 132 is connected to the compressor in one of several ways, such as a direct shaft drive, a belt drive, one or more clutches, and/or via an electrical generator/motor set. A refrigerant line 123 fluidly connects the components of the cooling unit 120.

Airflow is circulated into and through the cargo space of the enclosed volume 107 by means of the cooling unit 120. A return airflow 134 flows into the cooling unit 120 from the cargo space of the enclosed volume 107 through a cooling unit inlet 136, and across the evaporator 128 via the evaporator fan 130, thus cooling the return airflow 134 to a selected or predetermined temperature. The cooled return airflow 134, now referred to as supply airflow 138, is supplied into the cargo space of the enclosed volume 107 through a cooling unit outlet 140, which in some embodiments is located near the top wall 108 of the enclosed volume 107. The supply airflow 138 cools the cargo 118 in the cargo space of the enclosed volume 107. It is to be appreciated that the cooling unit 120 can further be operated to warm the enclosed volume 107 when, for example, the outside temperature is very low (e.g. in a heat pump operation). Those of skill in the art will appreciate that the airflow indicated in FIG. 1B (e.g., 134, 138) can be reversed without departing from the scope of the present disclosure, and the illustrated depiction of airflow/arrangement of elements is not intended to be limiting.

The cooling unit 120 is positioned in a frame 142 and contained in an accessible housing 144, with the frame 142 and/or the housing 144 secured to an exterior side of the front wall 114 such that the cooling unit 120 is positioned between the front wall 114 and the tractor 102, as shown in FIG. 1A.

The cooling unit 120 includes a power connector 146. Power connector 146 may be configured to receive a plug or other wired connection to supply electrical power to the cooling unit 120. When the enclosure system 100 is located at a port, loaded on a ship, attached to a tractor, etc., a power supply (not shown) may be connected to the power connector 146. When the enclosed volume 107 is moved from one location to another, the power connector 146 may be required to be disconnected from a power source such that the enclosed volume 107 is not physically connected to or wired to a power source, enabling freedom of movement of the enclosed volume 107. In some embodiments the power source include, but is not limited to, grid power, engine supplied power, auxiliary power unit power, etc.

It will be appreciated by those of skill in the art that the systems and configurations of FIGS. 1A and 1B are merely schematic examples and are provided for illustrative and descriptive purposes only. The disclosure is not limited thereby. For example, although a tractor-trailer configuration is shown, systems as described herein may be employed in other container configurations, in various truck configurations, and/or in other systems and configurations. Further, as will be appreciated by those of skill in the art, the container and cargo space of various embodiments may be configured as a sea container, and thus may be configured to stack with other containers and be shipped on a shipping vessel.

Transport refrigeration, such as shown in FIGS. 1A-1B, is typically based on vapor compression cooling cycles operated by a diesel engine either through a motor/generator set or directly with a belt drive. The compressor speed is determined by the generator frequency (e.g., electric drive) or engine speed (e.g., mechanical drive). As will be appreciated by those of skill in the art, the engine must be operated to provide the power to drive the refrigeration unit. However, it may be beneficial to have refrigeration systems that can be operated when the diesel engine is off or shut down (e.g., in areas with noise or emissions restrictions).

Accordingly, hybridized transport refrigeration units in accordance with embodiments of the present disclosure enable operation of a refrigeration unit, even when a diesel engine is shut down. In accordance with embodiments of the present disclosure, a battery is added to the system to allow the compressor to run even when the diesel engine is shut down. The battery is charged when the engine is on and the compressor is drawing less than full power. This is advantageous because the engine can operate at higher average power, thus improving specific fuel consumption.

Compressors can be fixed-speed or variable-speed. Although variable-speed compressors may be preferable based on cooling capacity control, such compressors are sometimes not used, often due to costs of variable-frequency drive electronics (i.e., fixed-speed compressors are simply cycled on/off to control capacity). In a hybrid system, in accordance with embodiments of the present disclosure, an AC compressor motor and fixed frequency generator are connected by an AC bus. Adding a battery requires the use of an AC/DC converter between the AC bus and the DC battery. Embodiments described herein are directed to using the DC/AC function of the battery converter to serve as a variable frequency drive when the compressor is being operated from the battery rather than the AC generator. Advantageously, such arrangement may be employed with a fixed-speed generator, and thus require little incremental cost to the converter and the compressor motor of traditional hybrid systems.

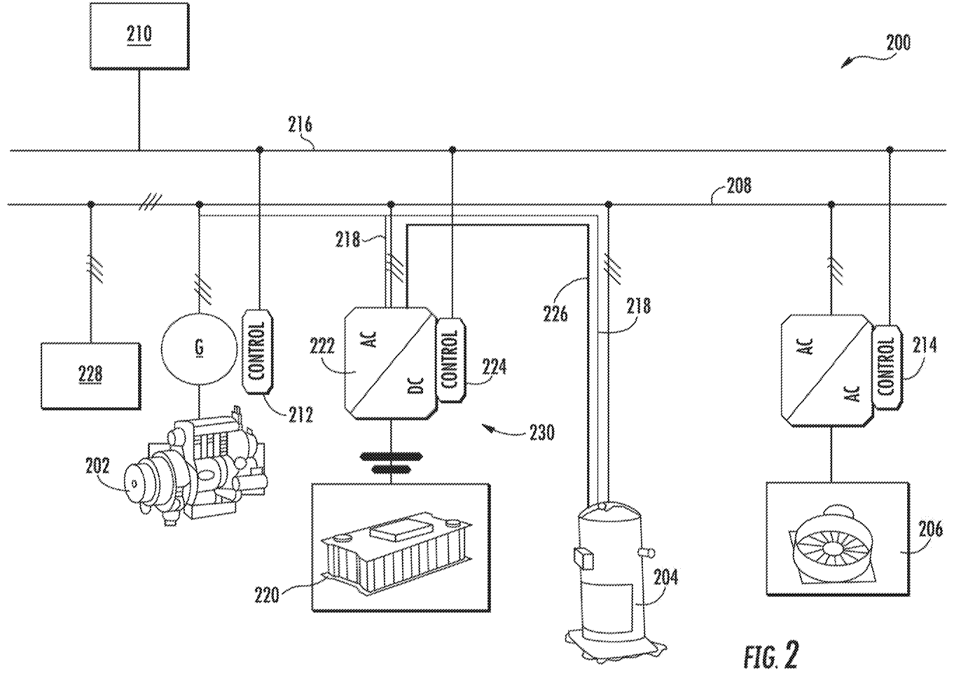

Turning now to FIG. 2, a schematic diagram of a refrigeration system 200 in accordance with an embodiment of the present disclosure is shown. The refrigeration system 200 can be a transport refrigeration system that is incorporated into a trailer, container, or other type of system, such as that shown and described above. The refrigeration system 200 includes a generator, such as a fixed-speed generator 202 that is arranged to drive a refrigeration compressor 204 and/or other loads 206 (e.g., fan(s), etc.). Various other components of the refrigeration system 200 are not shown for simplicity.

The fixed-speed generator 202 is electrically connected to the refrigeration compressor 204 and the other loads 206 by a power bus 208 that is arranged to distribute electricity to the refrigeration compressor 204 and the other loads 206. The fixed-speed generator 202 supplies a fixed frequency power supply to the refrigeration compressor 204 which cycles on and off to deliver a desired cooling capacity. In a traditional (non-hybrid) fixed speed system the compressor motor is not rated for inverter use to cut cost. However, a hybridized fixed speed system will require an inverter-rated motor because of the need for a DC/AC inverter when the battery is in use.

The fixed-speed generator 202 can be controlled by a system controller 210 that is in communication with the fixed-speed generator 202 (or a generator controller 212). The system controller 210 may be in communication with the loads 206 directly or through one or more load controllers 214. The system controller 210 is in communication with the other components along a communications bus 216. When the fixed-speed generator 202 is running, power can be supplied to the refrigeration compressor 204 along the power bus 208, as schematically shown as engine-operation mode 218.

As shown, the refrigeration system 200 also includes a power storage device 220. The power storage device 220 is a battery or similar energy sink that can be used to supply power along the power bus 208 to one or more components electrically connected thereto, including, but not limited to, the refrigeration compressor 204 and/or the other loads 206. The power storage device 220 is a DC load device and thus supplies DC power. However, those of skill in the art will appreciate that one or more components, including, but not limited to, the refrigeration compressor 204 and/or the other loads 206 may require AC power to operate. Accordingly, an AC/DC converter 222 is arranged between the power storage device 220 and the power bus 208. The device controller 210, as shown, is operably connected to and/or in communication with one or both of the power storage device 220 and/or a storage device controller 224. As shown, the storage device controller 224 is operably connected to the communications bus 216 and thus can be controlled by the system controller 210 and/or receive instructions from and/or provide data or information to the system controller 210. The power storage device 220 is electrically connected to the power bus 208 and can receive power from and/or supply power to the power bus 208.

In the engine-operation mode 218, as schematically shown, the power storage device 220 will receive power from the fixed-speed generator 202. The AC/DC converter 222 and storage device controller 224 are configured to receive AC power from the fixed-speed generator 202 through the power bus 208 and rectify the power to DC to charge or store the power in the power storage device 220.

At times, it may be advantageous to shut down the fixed-speed generator 202. During such times, the refrigeration compressor 204 may not be able to be run, as it doesn't receive power from the fixed-speed generator 202. Accordingly, in accordance with embodiments of the present disclosure, and as shown, the refrigeration system 200 can be operated in a battery-operation mode 226, which schematically illustrates power from the power storage device 220 flowing from the AC/DC converter 222 to the refrigeration compressor 204. In such operation the AC/DC converter 222 and storage device controller 224 become a DC/AC inverter 230. A fixed frequency inverter contains various components to enable a variable frequency drive, but lacks a controller to vary an outlet waveform, so it is advantageous to operate the DC/AC inverter 230 as a variable frequency drive when the battery is used. The function of the AC/DC converter 222 and storage device controller 224 reverses when the fixed-speed generator 202 is shut down so that power can be continuously supplied to the refrigeration compressor 204.

Even though the energy storage device 220 supplies DC power, the AC/DC converter 222 and storage device controller 224 are arranged to supply a variable frequency power to the refrigeration compressor 204, with the AC/DC converter 222 and storage device controller 224 arranged to enable a variable speed operation of the refrigeration compressor 204 through the conversion using the AC/DC converter 222 and storage device controller 224. Thus, a lower cost system having a fixed-speed generator 202 can be arranged with power storage to be used when the fixed-speed generator 202 is shut down, and also provide the efficiencies and benefits of a variable-speed system during battery operation.

As shown, an optional auxiliary power system 228 can be provided, as will be appreciated by those of skill in the art. The auxiliary power system 228 is a system that enables power supply from an auxiliary power source. For example, the auxiliary power system 228 can be a plugin system that can connect to grid power. The auxiliary power system 228 can include various controllers or other elements as will be appreciated by those of skill in the art.

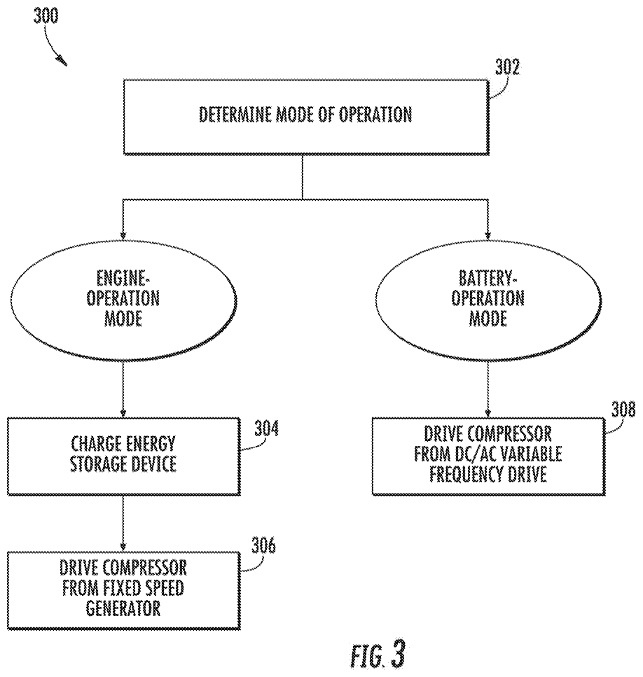

Turning now to FIG. 3, a flow process 300 in accordance with an embodiment of the present disclosure is shown. The flow process 300 is a method of operating a transport refrigeration system. The flow process 300 can be performed with one or more electrical components including controllers, processors, memory, etc. as will be appreciated by those of skill in the art. The flow process 300 can be performed by various components, either individually or collectively, such as, for example, the system controller 210 and/or the storage device controller 224 shown in FIG. 2.

At block 302, the current mode of operation is determined. The system may determine if a fixed-speed generator is currently operational (e.g., on state). When the fixed-speed generator is on and operating, the process determines that the system is in an engine-operation mode. In such a mode of operation, power from the fixed-speed generator is used to power and/or drive a refrigeration compressor, and other components.

For example, as shown at blocks 304-306, power from the fixed-speed generator is used to charge the energy storage device (block 304) and drive a compressor (block 306). Blocks 304-306 can be performed simultaneously from the power generated by the fixed-speed generator. In such operational mode, the power from the fixed-speed generator can be used to power other loads within the refrigeration system (e.g., fans, etc.). At block 304, the charging of the energy storage device is achieved using an AC/DC converter.

If, at block 302, it is determined that the engine (e.g., fixed-speed generator) is off, the system determines that battery-operation mode should be employed. Thus, the flow process continues to block 308 where power is supplied from the energy storage device to, at least, the compressor, with the power being variable frequency power. That is, a controller of the energy storage device converts into a DC/AC variable frequency drive when in the battery-operation mode. Accordingly, a battery or other energy storage device can be provide variable frequency power from a direct current power source, without substantial alteration to traditional refrigeration systems.

In some embodiments, the flow process can be triggered by a change in mode of operation. For example, when the engine-operation mode stops (e.g., engine/motor shuts off), the system can be arranged to automatically switch over to the battery-operation mode. Thus, the state of the engine will trigger the battery-operation mode.

Further, in some embodiments, the controller (e.g., storage device controller 224, system controller 210, or other controller in a system in accordance with embodiments of the present disclosure) can include various computer components including, but not limited to, a position locator element or other position/location element/component (e.g., GPS). As noted above, an advantage of hybridization is the ability to shut off a diesel engine in cities or other quiet zones that may be designated by regulation, etc. In some non-limiting embodiments, the use of a position locator (e.g., GPS locator, Wi-Fi location, etc.) may be employed to automatically switch from generator to battery when certain predesignated zones are entered, thus automatically avoiding any infractions.

Further, although described specifically with respect to the engine/motor being shut off and then operating in battery mode, such use in accordance with embodiments of the present disclosure is not only advantageous for quiet zones. For example, embodiments provided herein can be employed to save fuel, such as when a required capacity is low, and thus more efficient to run in battery mode as compared to engine mode of operation.

Advantageously, embodiments described herein provide hybrid transport refrigeration cycles in systems having fixed-speed generators and a power supply system with an AC/DC converter/controller arranged to supply variable speed/frequency power to a compressor to be operated when the fixed-speed generator is shut down. Advantageously, such hybrid system can achieve better efficiency in continuous operation as compared to traditional systems. Variable speed operation of the compressor under any part-load conditions can also result in better refrigeration cycle efficiency. Configuring the AC/DC converter to also serve as a DC/AC variable frequency drive enables both efficiency advantages with little to no additional cost to traditional systems.

While the present disclosure has been described in detail in connection with only a limited number of embodiments, it should be readily understood that the present disclosure is not limited to such disclosed embodiments. Rather, the present disclosure can be modified to incorporate any number of variations, alterations, substitutions, combinations, sub-combinations, or equivalent arrangements not heretofore described, but which are commensurate with the spirit and scope of the present disclosure. Additionally, while various embodiments of the present disclosure have been described, it is to be understood that aspects of the present disclosure may include only some of the described embodiments.

Accordingly, the present disclosure is not to be seen as limited by the foregoing description, but is only limited by the scope of the appended claims.

What is claimed is:

1. A hybrid-power transport refrigeration system comprising:
a fixed-speed generator;
a refrigeration compressor;
a power bus electrically connecting the fixed-speed generator to the refrigeration compressor;
an energy storage device electrically connected to the power bus and arranged to receive power from the fixed-speed generator in an engine-operation mode and to supply power to the refrigeration compressor in a battery-operation mode; and
a DC/AC variable frequency drive electrically connected between the energy storage device and the refrigeration compressor to convert a DC power supply from the energy storage device to a variable frequency power to drive the compressor when in the battery-operation mode.

2. The hybrid-power transport refrigeration system of claim 1, wherein the DC/AC variable frequency drive comprises an AC/DC converter and a storage device controller, wherein when in the engine-operation mode, the storage device controller is configured to convert power from the fixed-speed generator and store power in the energy storage device.

3. The hybrid-power transport refrigeration system of claim 2, wherein the storage device controller is further configured to reverse the AC/DC converter to a DC/AC converter and supply power to the refrigeration compressor.

4. The hybrid-power transport refrigeration system of claim 1, further comprising a system controller in communication with at least one of the fixed-speed generator and the DC/AC variable frequency drive.

5. The hybrid-power transport refrigeration system of claim 4, further comprising a communications bus enabling communication between the system controller and the at least one of the fixed-speed generator and the DC/AC variable frequency drive.

6. The hybrid-power transport refrigeration system of claim 1, further comprising at least one additional load electrically connected to the fixed-speed generator and arranged to be driven by power from the fixed-speed generator.

7. The hybrid-power transport refrigeration system of claim 1, further comprising a position locator element arranged to detect a position of the hybrid-power transport refrigeration system, wherein the battery-operation mode is based on the detected position.

8. The hybrid-power transport refrigeration system of claim 1, further comprising an auxiliary power system arranged to supply power to the power bus from an auxiliary power source.

9. The hybrid-power transport refrigeration system of claim 8, wherein the auxiliary power source is grid power.

10. The hybrid-power transport refrigeration system of claim 1, wherein the engine-operation mode is a mode of operation wherein the fixed-speed generator is on and operated and the battery-operation mode is employed when the fixed-speed generator is off and shut down.

11. The hybrid-power transport refrigeration system of claim 1, wherein the refrigeration compressor is a variable speed compressor.

12. A method of operating a transport refrigeration system, the method comprising:
operating a fixed-speed generator to power a refrigeration compressor through a power bus electrically connecting the fixed-speed generator to the refrigeration compressor;
storing power in an energy storage device that is electrically connected to the power bus and arranged to receive power from the fixed-speed generator in an engine-operation mode and to supply power to the refrigeration compressor in a battery-operation mode; and
converting a DC power stored in the energy storage device to a variable frequency AC power to drive the compressor when in a battery-operation mode using a DC/AC variable frequency drive electrically connected between the energy storage device and the refrigeration compressor, wherein the battery-operation mode is used when the fixed-speed generator is off.

13. The method of claim 12, wherein the DC/AC variable frequency drive comprises an AC/DC converter and a storage device controller, the method further comprising:
converting power from the fixed-speed generator to store power in the energy storage device when in the engine-operation mode.

14. The method of claim 13, further comprising:
reversing the AC/DC converter to a DC/AC inverter; and
supplying power to the refrigeration compressor.

15. The method of claim 12, further comprising supplying power to at least one additional load that is electrically connected to the fixed-speed generator and arranged to be driven by power from the fixed-speed generator.

16. The method of claim 12, further comprising detecting a position of the hybrid-power transport refrigeration system using a position locator element, wherein use of the battery-operation mode is based on the detected position.

17. The method of claim 12, further comprising supplying power from an auxiliary power system source to the power bus.

18. The method of claim 17, wherein the auxiliary power source is grid power.

19. The method of claim 12, wherein the engine-operation mode is a mode of operation wherein the fixed-speed generator is on and operated and the battery-operation mode is employed when the fixed-speed generator is off and shut down.

20. The method of claim 12, wherein the refrigeration compressor is a variable speed compressor.
